(19) United States
(12) Patent Application Publication
(10) Pub. No.: US 2024/0027204 A1
(43) Pub. Date: Jan. 25, 2024

(54) SYSTEMS AND METHODS FOR GENERATING A TRIP PLAN WITH TRIP RECOMMENDATIONS

(71) Applicant: Capital One Services, LLC, McLean, VA (US)

(72) Inventors: Lin Ni Lisa Cheng, New York, NY (US); Zinab Bauwens, Glen Allen, VA (US); Wade Rance, Washington, DC (US); Alexis Howard, Cobbs Creek, VA (US)

(21) Appl. No.: 17/868,693

(22) Filed: Jul. 19, 2022

(51) Int. Cl. G01C 21/34; G01C 21/36

(52) U.S. Cl. CPC G01C 21/343; G01C 21/3664; G01C 21/3614

(57) ABSTRACT

Disclosed embodiments may include a method for generating a trip plan with trip recommendations. The method may include generating and transmitting a graphical user interface to a user device and receiving, from the user device, criteria, which is then used to retrieve candidate data. The criteria and candidate data may then be used to generate potential leads using a machine learning model. The method may include generating a graphical user interface to display the potential leads and receive timing and preference data from the user. The method may further include generating, using a machine learning model, a plan based on the potential leads and other data. The plan may be presented to a user via graphical user interface, which may be used to modify and update the plan. The plan may be stored and accessed by the user at a later time through a user device.

The disclosed technology relates to systems and methods for generating a trip plan with trip recommendations. Specifically, this disclosed technology relates to planning trips for relationship managers to visit clients.

### BACKGROUND

Relationship managers add an important personal touch to the modern business world. Many businesses that sell services to other businesses have employees that frequently visit clients to “check-in” and see how current services are working out. For example, if a bank provides merchant and banking services to a restaurant, the bank may have an employee (or relationship manager) that gets to know the owner and manager of the restaurant and becomes their point-of-contact for questions regarding services within the bank. An important part of building this relationship is having the relationship manager “check-in” at the client's place of business on a fairly regular basis. This helps the relationship manager to get to know the client's business better and also helps to increase the number of sales interactions between the businesses.

Traditional systems and methods for generating a trip plan requires manual planning by relationship managers. Similar to planning a vacation, this is a time-consuming process that can be organizationally difficult. Relationship managers spend a significant amount of time planning each trip and researching target clients. This sometimes can take as much time as the trip itself. This time could otherwise be used to cultivate new client relationships or augment existing ones. Additionally, relationship managers may miss out on opportunities to meet clients they would have otherwise skipped because they were unaware that the client was near another client they planned on visiting.

Accordingly, there is a need for improved systems and methods for generating trip plans. Embodiments of the present disclosure are directed to this and other considerations.

### SUMMARY

Disclosed embodiments may include a system for generating a trip plan with trip recommendations. The system may include one or more processors, and memory in communication with the one or more processors and storing instructions that, when executed by the one or more processors, are configured to cause the system to generate a trip plan with trip recommendations. The system may receive criteria. The system may also retrieve, based on the criteria, candidate data. Additionally, the system may generate, using a first machine learning model, potential leads according to the criteria and the candidate data. Furthermore, the system may receive timing data and preference data. The system may also generate, using a second machine learning model, a plan based on the potential leads, the timing data, and the preference data. Finally, the system may store the plan, wherein the plan can be accessed by a user device.

Disclosed embodiments may include a system for generating a trip plan with trip recommendations. The system may include one or more processors, and memory in communication with the one or more processors and storing instructions that, when executed by the one or more processors, are configured to cause the system to generate a trip plan with trip recommendations. The system may generate a first graphical user interface to prompt criteria from a user. The system may also transmit, to a user device, the first graphical user interface for display. Furthermore, the system may receive criteria from the user device. Additionally, the system may retrieve, based on the criteria, candidate data. The system may also generate, using a first machine learning model, potential leads according to the criteria and the candidate data. The system may generate a second graphical user interface comprising the potential leads, prompting timing data, and prompting preference data from the user. The system may transmit, to the user device, the second graphical user interface for display. Additionally, the system may receive, from the user device, the timing data and the preference data. Furthermore, the system may generate, using a second machine learning model, a plan based on the potential leads, the timing data, and the preference data. The system may also generate a third graphical user interface comprising an interactive map with the potential leads and travel information from the plan. Finally, the system may transmit, to the user device, the third graphical user interface for display.

Disclosed embodiments may include a system for generating a trip plan with trip recommendations. The system may include one or more processors, and memory in communication with the one or more processors and storing instructions that, when executed by the one or more processors, are configured to cause the system to generate a trip plan with trip recommendations. The system may passively receive criteria from a user device. The system may also retrieve, based on the criteria, candidate data. The system additionally may automatically generate, using a first machine learning model, potential leads according to the criteria and the candidate data. Furthermore, the system may automatically transmit, to the user device, recommendations for potential leads. The system may also receive timing data and preference data. Additionally, the system may generate, using a second machine learning model, a plurality of plans based on the potential leads, the timing data, and the preference data. Finally, the system may store the plurality of plans, wherein the plurality of plans can be accessed by the user device.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for generating a trip plan with trip recommendations in accordance with certain embodiments of the disclosed technology.

FIG. 2 is block diagram of an example trip planning system used to generate a trip plan with trip recommendations, according to an example implementation of the disclosed technology.

FIG. 3 is block diagram of an example system that may be used to generate a trip plan with trip recommendations, according to an example implementation of the disclosed technology.

### DETAILED DESCRIPTION

Examples of the present disclosure related to systems and methods for generating a trip plan with trip recommendations. More particularly, the disclosed technology relates to trip planning and organization for relationship managers. The systems and methods described herein utilize, in some instances, machine learning models, which are necessarily rooted in computers and technology. Machine learning models are a unique computer technology that involves training models to complete tasks and make decisions. The present disclosure details organizing trip plans from generated potential leads, data provided by the user, and data provided by the client. This, in some examples, may involve using input data regarding stops to visit based on potential and current clients and a machine learning model that schedules an optimal route using the input data. Using a machine learning model in this way may allow the system to save time while better organizing trip appointment planning. This is a clear advantage and improvement over prior technologies that take a significant amount of time and result in less-optimized routes. The present disclosure solves this problem by using machine learning models to develop new client leads and organize trips that contain stops at potential clients and current clients.

Furthermore, the systems and methods described herein utilize, in some instances, graphical user interfaces, which are necessarily rooted in computers and technology. Graphical user interfaces are a computer technology that allows for user interaction with computers through touch, pointing devices, or other means. The present disclosure details a trip planning system. This, in some examples, may involve using user inputs and other data to dynamically change a graphical user interface containing an interactive map or list with routing information about trip stops. Using a graphical user interface in this way may allow the system to actively change the route plan in response to input or feedback from the user. Overall, the systems and methods disclosed have significant practical applications in the relationship manager customer development field because of the noteworthy improvements leveraging machine learning models and graphical user interfaces to improve trip planning and organization, which are important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

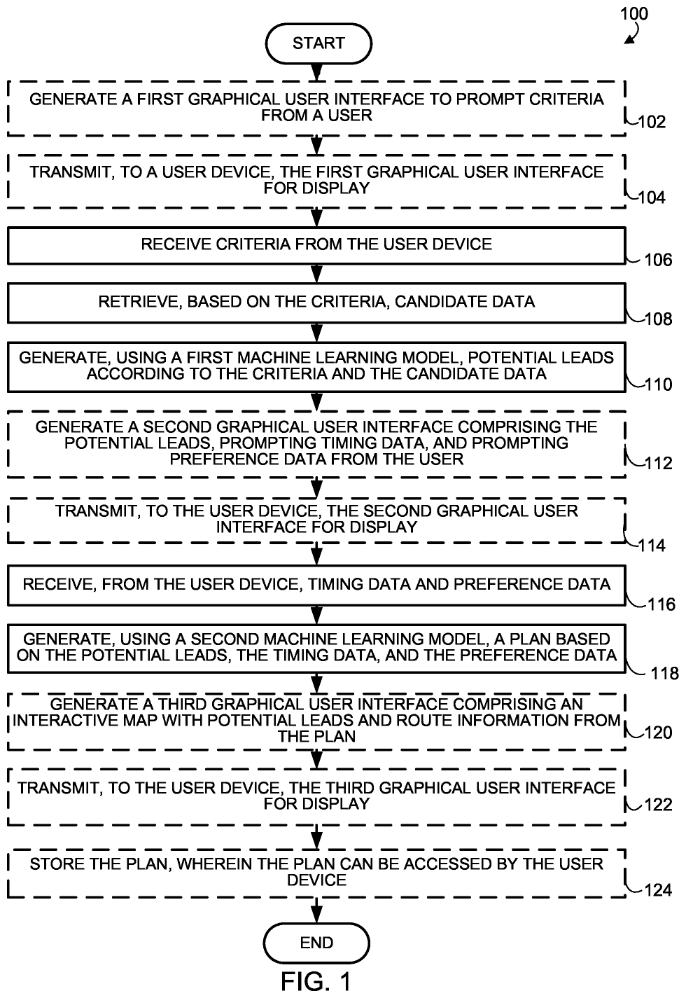

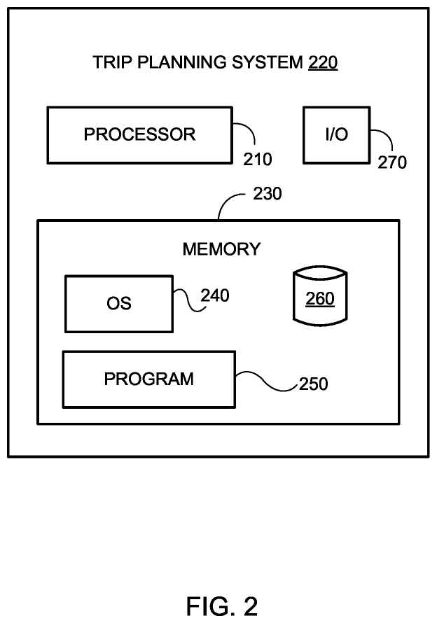

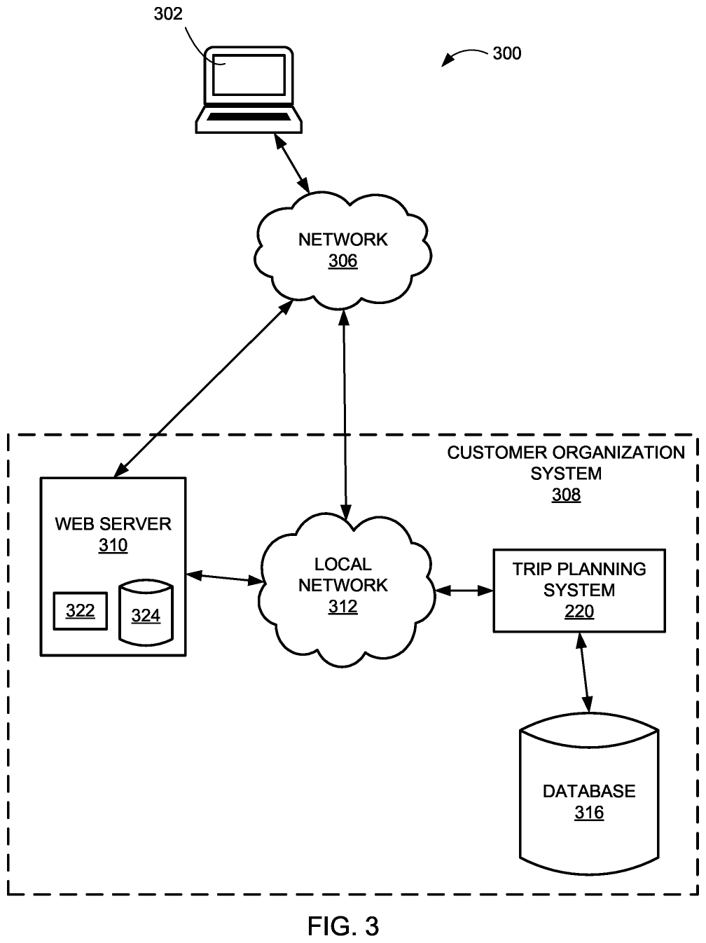

FIG. 1 is a flow diagram illustrating an exemplary method 100 for generating a trip plan with trip recommendations, in accordance with certain embodiments of the disclosed technology. The steps of method 100 may be performed by one or more components of the system 300 (e.g., trip planning system 220 or web server 310 of customer organization system 308 or user device 302), as described in more detail with respect to FIGS. 2 and 3.

In optional block 102, the trip planning system 220 may generate a graphical user interface to prompt criteria from a user. The user may be a relationship manager looking to go on a trip in the near future. Criteria may be information regarding the trip including the dates of the trip, the approximate distance the user is willing to travel, the number of stops, the amount of time in between stops, and/or the types of businesses the user is interested in visiting (e.g., a preferred category of prospect). Stops may refer to a specific location, such as a business or client, or be more general, such as a city or county. Criteria may also include information about the user that is not user-selected but based on a user profile in a database or known user preferences. Information in the user profile may include the amount of experience of the user, and the user's primary client types (e.g., what types of businesses make up the largest parts of the user's portfolio). The criteria may also include factors driven by businesses goals, such as quotas or business development aims. The criteria may also include business needs, like meeting with the manager of a business who is having trouble with services. The criteria may also include information from other relationship manager users, such as the last time any relationship manager had visited a certain area. The trip planning system 220 may also include recommendations for criteria based on the user profile or business goals.

The graphical user interface may be, in part, an interactive map, which allows the user to draw a box on the map representing the approximate area of clients that they would like to visit on this particular trip. The user may be able to select certain cities, counties, municipalities, and/or states on the interactive map that they would like to potentially visit. The user may also be able to enter or select certain zip codes to visit. Furthermore, the graphical user interface may contain an interactive calendar that may interface with the user's personal calendar. The interactive calendar may show specific dates of interest for the particular area that the user has chosen on the map. Furthermore, the graphical user interface may further contain categories of dropdown menus and checkboxes containing options for the user to select regarding the trip. These options may constitute further criteria and include options such as only scheduling stops between certain hours and/or minimizing overnight stays.

In optional block 104, the trip planning system 220 may transmit, to a user device, the first graphical user interface for display. The user device may be a computer, such as a desktop or laptop, and may use typical user interface devices, such as a mouse and keyboard, or may use a touchscreen. The user device may be a mobile device such as a smartphone. If the user has more than one user device, the graphical user interface may be transmitted to both devices. The graphical user interface may be displayed in a native application operated on the user device. The user device may be able to access the graphical user interface through a dedicated webpage.

In block 106, the trip planning system 220 may receive the criteria from the user device. This may be in response to the prompt for information from the graphical user interface transmitted in block 104. The receipt of the information may be passive, and without the knowledge or intention of the user. The trip planning system 220 may run in the background and present ideas to the user.

In block 108, the trip planning system 220 may retrieve candidate data based on the criteria. The trip planning system 220 may recognize certain criteria and retrieve additional information (candidate data) based on the criteria. For example, if a user draws out a certain area on the interactive map that the user would like to visit, the trip planning system 220 may search for new businesses that have opened in that area. The trip planning system 220 may search for current clients that operate businesses within that area. For businesses in the area selected, the trip planning system 220 may retrieve information regarding opening data, closing data, frequency of business data (e.g., how busy the business is at a certain time), feedback from a plurality of users (e.g., feedback from other relationship managers), estimated revenue, employee size, and/or customer feedback of the business (e.g., customer reviews). This information may be retrieved from a customer database or external (or 3^{rd} party) data sources (e.g., such as Google Maps for opening and closing data).

In block 110, the trip planning system 220 may generate potential leads according to the criteria and the candidate data. The trip planning system 220 may use a machine learning model or an ensemble of machine learning models to generate the potential leads from the criteria and candidate data. The trip planning system 220 may separate the new potential client leads from existing client leads. The potential leads chosen by the trip planning system 220 may be leads that fit the criteria given by the user. For example, if the user chose to visit clients who are restaurants, the trip planning system 220 would select leads that are restaurants. The trip planning system 220 may be able to deviate from the criteria in certain circumstances when opportunities present (e.g., when a user chose restaurants, but a major medical office client was in the area, the trip planning system 220 may also generate the medical office as a potential lead, or when a company objective is to check-in on clients that recently had a bad experience and there is a company that is not in the correct category of businesses, but is within the specified area that fits those criteria). The trip planning system 220 may have some discretion in choosing potential leads for a trip based on a number of factors. For example, if a client was recently visited by another user, the trip planning system 220 may not generate that client as a potential lead since another user had just visited the client.

For the new potential client leads, the trip planning system 220 may determine if a business is new based on the external data provided. The machine learning model may output a confidence score which shows how accurate the rating of the business as “new” is. Furthermore, the trip planning system 220 may determine the best time to visit the new potential clients. This may involve looking at the open time of the business, closing time of the business, and the times of day the business is busy. The best time to visit new potential clients may be when the business is the least busy. The trip planning system 220 may determine the best time to visit each new potential client lead by finding a time of day that the business is not as busy. The trip planning system 220 may also complete this process for existing client leads with the aid of further private information known about the client (e.g., from the files on the client). The machine learning model may contain a feedback loop which incorporates feedback on visit time selection and new potential client leads from previous users, which aids in the selection of new visit time selection and further potential client leads. The machine learning model may also attempt to determine if any new potential leads are new locations for current customers. Furthermore, the machine learning model may determine a recommendation of whether that potential lead would prefer an appointment or if the user should just drop-by.

Trip planning system 220 may include an additional machine learning model or an ensemble of machine learning models that are used to predict the success of a new potential client lead based on the candidate data and other data. The machine learning model or ensemble of machine learning models may use data regarding past businesses in the area of the same business category (e.g., comparing a new restaurant to an older restaurant in the same area) and determine how valuable a client will probably be in the future based off of revenue projections. The machine learning model or ensemble of machine learning models may estimate the overall revenue of a business for the next year or the next several years. The machine learning model or ensemble of machine learning models may rank the new potential client leads based on the overall estimated revenue.

In optional block 112, the trip planning system 220 may generate a graphical user interface comprising the potential leads and prompting the user to provide timing data and preference data. The graphical user interface may present the generated potential leads from block 110 to the user. The potential leads may include a combination of new client potential leads or current clients leads. The combination of potential leads between new and current clients may be a result of a user choice in the criteria. The potential leads may be presented in a list. The list may include a ranking system where the leads are ranked by revenue estimates. The list may also be ranked by alignment with business goals (e.g., if a business goal is to obtain more clients of X type, then clients of X type may be ranked before other clients). The potential leads may also be presented on an interactive map. The interactive map may show the boundaries of the selection of the criteria and may show the potential leads on the map. The potential leads may be shown as pins on the map. New potential leads may be distinguished from current client leads by different colored pins or indicators on the map. When a user selects one of the pins, it may show more information about that potential lead, such as name of the company, address, hours of operation, recommended visiting hours, contact information, and if available, a point of contact and contact information for the point of contact. The graphical user interface may also show if the trip planning system 220 recommends that the user schedule an appointment or drop-by.

From the graphical user interface, the user may be able to provide timing data and preference data. The timing data and preference data may completely or partially come from the criteria received from the user in block 106. The preference data may include a selection, by the user, of which potential leads the user would like to visit on this trip. The user may optionally rank the selection of the potential leads. The user may also indicate whether they agree or disagree with the trip planning system 220 whether the potential lead requires an appointment or if the user should just drop by. The preference data and/or criteria may further include a variable scheduling preference that may range from relaxed to strenuous. A relaxed plan may give the user a significant amount of time between stops to look around and develop additional connections. A strenuous plan may setup back-to-back stops with just enough time to make each appointment. This way the user can choose how they want to setup their trip. There may be a plurality of options in between the relaxed setting and the strenuous setting. The scheduling preference may include a slider on the graphical user interface that the user can slide to the appropriate spot.

Timing data may include times chosen by the user that would be most appropriate to visit the potential lead. The trip planning system 220 may suggest times to visit the potential lead based on the candidate data processed in block 110, but the user may disagree with the times suggested by trip planning system 220. By submitting timing data, the user may suggest new ties that would be more appropriate for the potential lead (e.g., in the user's experience, this current client only likes visits between 1-3 pm). The submission of timing data by the user may be optional.

The user may be able to select an option indicating that the potential lead may have been an improper suggestion. This feedback information may be used to train the machine learning model. Furthermore, the machine learning model may use the potential leads that the user selects (the preference data) as additional feedback for the machine learning model.

In optional block 114, the trip planning system 220 may transmit the graphical user interface to the user device. This may follow generally the details presented regarding the user interface in block 104.

In block 116, the trip planning system 220 may receive, from the user device, the timing data and the preference data. This may be in response to the prompt for information from the graphical user interface transmitted in block 114. In an alternative embodiment, the user may not have to pick the potential leads as part of the preference data and may provide any timing data (if needed) as part of the criteria. In this alternative embodiment, the trip planning system 220 may choose the potential leads for the user to visit on the trip and appropriate times without feedback or changes from the user.

In block 118, the trip planning system 220 may generate a plan based on the potential leads, the timing data, and/or the preference data. The trip planning system 220 may generate the plan using an additional machine learning model or an ensemble of machine learning models. The plan may include an itinerary with an assortment of stops at different potential leads. The potential leads may be organized by appointment times according to what was determined to be the best time for the user to visit the client. The plan may be generated with specific attention to the location proximity of the different potential leads. The plan may be designed to optimize visits to an area. The stops at potential leads may include data on if the stop should be by appointment or be a drop-by. The itinerary may also include route information including directions and estimates for travel time. The itinerary may also include break times for the user. The itinerary may also include necessary overnight stays, hotel options, and a hotel and/or travel expense budget.

For potential leads that are designated to be visited with a “drop-by,” the trip planning system 220 may set aside a block of time for the user to visit the potential lead during times when the potential lead is not busy (e.g., not peak hours). For potential leads that are designated to be visited “by appointment,” the trip planning system 220 may prompt the user to allow for automated scheduling. This may be distributed to the user as part of the graphical user interface generated in block 120. The user may select to allow trip planning system 220 to automatically schedule appointments with potential leads. The appointment schedule may be based on the times determined that the potential lead would likely not be busy. Accordingly, the trip planning system 220 will send, to a 3^{rd} party user device associated with the potential lead, using an automated email or text message, an invitation to meet with the potential lead at the appropriate time (coordinated with the plan). The trip planning system 220 may receive appointment information indicating whether the potential lead has accepted or declined the invitation. If the potential lead accepts the invitation, the trip planning system 220 notes that the appointment has been confirmed. If the potential lead declines the invitation, the invitation may ask the potential lead for an alternative time. If an alternative time is available, trip planning system 220 may reroute the plan using the machine learning model to accommodate the needs of the potential lead. If the potential lead does not provide an alternative time, the trip planning system 220 may reroute the plan to compensate for the lack of meeting during the anticipated time using the machine learning model.

Alternatively, the user may decide to not automatically schedule appointments for some potential leads (e.g., new customers, customers that do not use email often). Therefore, the user may want to call and setup appointments separately. The trip planning system 220 may have the ability to receive appointment information from the user device. The appointment information may then be used to revise the plan using the machine learning model.

The trip planning system 220 may, in some embodiments, require 3^{rd} party information to optimize the plan. This may involve transmitting, to a 3^{rd} party, plan data regarding the plan. The plan data may include the different locations of the stops at potential leads. The trip planning system 220 may receive optimized travel information from the 3r d party based on the plan data. The optimized travel information may include optimized route information, and/or more accurate travel times and directions. The trip planning system 220 may then adjust the plan based on the optimized travel information.

In optional block 120, the trip planning system 220 may generate a graphical user interface comprising an interactive map with the potential leads and route information from the plan. The graphical user interface may allow the user to change routes and times to visit potential leads. Changes made to the graphical user interface may also change the underlying plan. The trip planning system 220 may change the plan accordingly to accommodate the user changes (e.g., if the user does not want to visit XYZ client, at 2 pm, then they can change the plan so that they meet XYZ client at 10 am). The user may also have an option through the graphical user interface to add/subtract potential lead visits and otherwise modify the plan as they see fit. Alternatively, the graphical user interface may be presented as an interactive list featuring the potential leads and travel information in a chronological order. The user may be able to select and switch between “map view” and “list view” when examining the plan on the graphical user interface.

In optional block 122, the trip planning system 220 may transmit the graphical user interface to the user device. This may follow generally the details presented regarding the graphical user interface in block 104.

In optional block 124, the trip planning system 220 may store the plan and/or itinerary. The plan may be stored in a database, such as database 260 or database 316 where the user device can access the plan. The user may have to indicate to save the plan for future use. Additionally, the trip planning system 220 may create several plan options and present all the plans to the user at one time. The graphical user interface may be designed so that the user can compare all of the possible plans and the user may be able to select and/or save the plan that they like the best. Once the user selects a plan an additional graphical user interface may be generated and transmitted that shows details about the chosen plan.

The plan may be accessed from the database when the user goes to start the trip. The plan may be accessed from more than one of the user's devices. For example, the user may create the plan using their laptop computer and then access the plan using their smartphone. The trip planning system 220 may change graphical user interfaces between user devices (e.g., one graphical user interface presented on a smartphone and another for a laptop). Furthermore, the trip planning system 220 may have a “use mode” that is a simplified interface after the trip plan is created and saved that allows the plan to actively update as the user completes the plan. This may require the user to “check-off” certain steps of the plan. Alternatively, the trip planning system 220 may monitor the user's progress through location information provided by the user device. If the user deviates from the plan, the trip planning system 220 may recalculate the plan and/or itinerary to take advantage of otherwise potentially lost time and direct the user to other potential leads in the area. The user may additionally be able to upload the plan to a compatible vehicle infotainment system and the vehicle may be able to monitor the user's progress.

FIG. 2 is a block diagram of an example trip planning system 220 used to create and organize trip plans according to an example implementation of the disclosed technology. According to some embodiments, the user device 302 and web server 310, as depicted in FIG. 3 and described below, may have a similar structure and components that are similar to those described with respect to trip planning system 220 shown in FIG. 2. As shown, the trip planning system 220 may include a processor 210, an input/output (I/O) device 270, a memory 230 containing an operating system (OS) 240 and a program 250. In certain example implementations, the trip planning system 220 may be a single server or may be configured as a distributed computer system including multiple servers or computers that interoperate to perform one or more of the processes and functionalities associated with the disclosed embodiments. In some embodiments trip planning system 220 may be one or more servers from a serverless or scaling server system. In some embodiments, the trip planning system 220 may further include a peripheral interface, a transceiver, a mobile network interface in communication with the processor 210, a bus configured to facilitate communication between the various components of the trip planning system 220, and a power source configured to power one or more components of the trip planning system 220.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 210 to communicate with other devices via wired or wireless networks, whether local or wide area, private or public, as known in the art. A power source may be configured to provide an appropriate alternating current (AC) or direct current (DC) to power components.

The processor 210 may include one or more of a microprocessor, microcontroller, digital signal processor, co-processor or the like or combinations thereof capable of executing stored instructions and operating upon stored data. The memory 230 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 230.

The processor 210 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 210 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 210 may be a single core processor that is configured with virtual processing technologies. In certain embodiments, the processor 210 may use logical processors to simultaneously execute and control multiple processes. The processor 210 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the trip planning system 220 may include one or more storage devices configured to store information used by the processor 210 (or other components) to perform certain functions related to the disclosed embodiments. In one example, the trip planning system 220 may include the memory 230 that includes instructions to enable the processor 210 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The trip planning system 220 may include a memory 230 that includes instructions that, when executed by the processor 210, perform one or more processes consistent with the functionalities disclosed herein. Methods, systems, and articles of manufacture consistent with disclosed embodiments are not limited to separate programs or computers configured to perform dedicated tasks. For example, the trip planning system 220 may include the memory 230 that may include one or more programs 250 to perform one or more functions of the disclosed embodiments. For example, in some embodiments, the trip planning system 220 may additionally manage dialogue and/or other interactions with the customer via a program 250.

The processor 210 may execute one or more programs 250 located remotely from the trip planning system 220. For example, the trip planning system 220 may access one or more remote programs that, when executed, perform functions related to disclosed embodiments.

The memory 230 may include one or more memory devices that store data and instructions used to perform one or more features of the disclosed embodiments. The memory 230 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 230 may include software components that, when executed by the processor 210, perform one or more processes consistent with the disclosed embodiments. In some embodiments, the memory 230 may include a trip planning system database 260 for storing related data to enable the trip planning system 220 to perform one or more of the processes and functionalities associated with the disclosed embodiments.

The trip planning system database 260 may include stored data relating to status data (e.g., average session duration data, location data, idle time between sessions, and/or average idle time between sessions) and historical status data. According to some embodiments, the functions provided by the trip planning system database 260 may also be provided by a database that is external to the trip planning system 220, such as the database 316 as shown in FIG. 3.

The trip planning system 220 may also be communicatively connected to one or more memory devices (e.g., databases) locally or through a network. The remote memory devices may be configured to store information and may be accessed and/or managed by the trip planning system 220. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The trip planning system 220 may also include one or more I/O devices 270 that may comprise one or more interfaces for receiving signals or input from devices and providing signals or output to one or more devices that allow data to be received and/or transmitted by the trip planning system 220. For example, the trip planning system 220 may include interface components, which may provide interfaces to one or more input devices, such as one or more keyboards, mouse devices, touch screens, track pads, trackballs, scroll wheels, digital cameras, microphones, sensors, and the like, that enable the trip planning system 220 to receive data from a user (such as, for example, via the user device 302).

In examples of the disclosed technology, the trip planning system 220 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The trip planning system 220 may contain programs that train, implement, store, receive, retrieve, and/or transmit one or more machine learning models. Machine learning models may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The trip planning system 220 may be configured to adjust model parameters during training. Model parameters may include weights, coefficients, offsets, or the like. Training may be supervised or unsupervised.

The trip planning system 220 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The trip planning system 220 may be configured to optimize statistical models using known optimization techniques.

Furthermore, the trip planning system 220 may include programs configured to retrieve, store, and/or analyze properties of data models and datasets. For example, trip planning system 220 may include or be configured to implement one or more data-profiling models. A data-profiling model may include machine learning models and statistical models to determine the data schema and/or a statistical profile of a dataset (e.g., to profile a dataset), consistent with disclosed embodiments. A data-profiling model may include an RNN model, a CNN model, or other machine-learning model.

The trip planning system 220 may include algorithms to determine a data type, key-value pairs, row-column data structure, statistical distributions of information such as keys or values, or other property of a data schema may be configured to return a statistical profile of a dataset (e.g., using a data-profiling model). The trip planning system 220 may be configured to implement univariate and multivariate statistical methods. The trip planning system 220 may include a regression model, a Bayesian model, a statistical model, a linear discriminant analysis model, or other classification model configured to determine one or more descriptive metrics of a dataset. For example, trip planning system 220 may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

The trip planning system 220 may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, trip planning system 220 may be configured to generate a similarity metric representing a measure of similarity between data in a dataset. A similarity metric may be based on a correlation, covariance matrix, a variance, a frequency of overlapping values, or other measure of statistical similarity.

The trip planning system 220 may be configured to generate a similarity metric based on data model output, including data model output representing a property of the data model. For example, trip planning system 220 may be configured to generate a similarity metric based on activation function values, embedding layer structure and/or outputs, convolution results, entropy, loss functions, model training data, or other data model output). For example, a synthetic data model may produce first data model output based on a first dataset and a produce data model output based on a second dataset, and a similarity metric may be based on a measure of similarity between the first data model output and the second-data model output. In some embodiments, the similarity metric may be based on a correlation, a covariance, a mean, a regression result, or other similarity between a first data model output and a second data model output. Data model output may include any data model output as described herein or any other data model output (e.g., activation function values, entropy, loss functions, model training data, or other data model output). In some embodiments, the similarity metric may be based on data model output from a subset of model layers. For example, the similarity metric may be based on data model output from a model layer after model input layers or after model embedding layers. As another example, the similarity metric may be based on data model output from the last layer or layers of a model.

The trip planning system 220 may be configured to classify a dataset. Classifying a dataset may include determining whether a dataset is related to another datasets. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may and indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The trip planning system 220 may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some embodiments, trip planning system 220 is configured to generate and/or train a classification model to classify a dataset, consistent with disclosed embodiments.

The trip planning system 220 may also contain one or more prediction models. Prediction models may include statistical algorithms that are used to determine the probability of an outcome, given a set amount of input data. For example, prediction models may include regression models that estimate the relationships among input and output variables. Prediction models may also sort elements of a dataset using one or more classifiers to determine the probability of a specific outcome. Prediction models may be parametric, non-parametric, and/or semi-parametric models.

In some examples, prediction models may cluster points of data in functional groups such as “random forests.” Random Forests may comprise combinations of decision tree predictors. (Decision trees may comprise a data structure mapping observations about something, in the “branch” of the tree, to conclusions about that thing's target value, in the “leaves” of the tree.) Each tree may depend on the values of a random vector sampled independently and with the same distribution for all trees in the forest. Prediction models may also include artificial neural networks. Artificial neural networks may model input/output relationships of variables and parameters by generating a number of interconnected nodes which contain an activation function. The activation function of a node may define a resulting output of that node given an argument or a set of arguments. Artificial neural networks may generate patterns to the network via an ‘input layer’, which communicates to one or more “hidden layers” where the system determines regressions via a weighted connections. Prediction models may additionally or alternatively include classification and regression trees, or other types of models known to those skilled in the art. To generate prediction models, the trip planning system may analyze information applying machine-learning methods.

While the trip planning system 220 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the trip planning system 220 may include a greater or lesser number of components than those illustrated.

FIG. 3 is a block diagram of an example system that may be used to view and interact with customer organization system 308, according to an example implementation of the disclosed technology. The components and arrangements shown in FIG. 3 are not intended to limit the disclosed embodiments as the components used to implement the disclosed processes and features may vary. As shown, customer organization system 308 may interact with a user device 302 via a network 306. In certain example implementations, the customer organization system 308 may include a local network 312, a trip planning system 220, a web server 310, and a database 316.

In some embodiments, a user may operate the user device 302. The user device 302 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 306 and ultimately communicating with one or more components of the customer organization system 308. In some embodiments, the user device 302 may include or incorporate electronic communication devices for hearing or vision impaired users.

Users may be relationship managers or employees of an entity associated with the customer organization system 308. According to some embodiments, the user device 302 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The trip planning system 220 may include programs (scripts, functions, algorithms) to configure data for visualizations and provide visualizations of datasets and data models on the user device 302. This may include programs to generate graphs and display graphs. The trip planning system 220 may include programs to generate histograms, scatter plots, time series, or the like on the user device 302. The trip planning system 220 may also be configured to display properties of data models and data model training results including, for example, architecture, loss functions, cross entropy, activation function values, embedding layer structure and/or outputs, convolution results, node outputs, or the like on the user device 302.

The network 306 may be of any suitable type, including individual connections via the internet such as cellular or WiFi networks. In some embodiments, the network 306 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 306 may include any type of computer networking arrangement used to exchange data. For example, the network 306 may be the Internet, a private data network, virtual private network (VPN) using a public network, and/or other suitable connection(s) that enable(s) components in the system 300 environment to send and receive information between the components of the system 300. The network 306 may also include a PSTN and/or a wireless network.

The customer organization system 308 may be associated with and optionally controlled by one or more entities such as a business, corporation, individual, partnership, or any other entity that provides one or more of goods, services, and consultations to individuals such as customers. In some embodiments, the customer organization system 308 may be controlled by a third party on behalf of another business, corporation, individual, partnership. The customer organization system 308 may include one or more servers and computer systems for performing one or more functions associated with products and/or services that the organization provides.

Web server 310 may include a computer system configured to generate and provide one or more websites accessible to customers, as well as any other individuals involved in access system 308's normal operations. Web server 310 may include a computer system configured to receive communications from user device 302 via for example, a mobile application, a chat program, an instant messaging program, a voice-to-text program, an SMS message, email, or any other type or format of written or electronic communication. Web server 310 may have one or more processors 322 and one or more web server databases 324, which may be any suitable repository of website data. Information stored in web server 310 may be accessed (e.g., retrieved, updated, and added to) via local network 312 and/or network 306 by one or more devices or systems of system 300. In some embodiments, web server 310 may host websites or applications that may be accessed by the user device 302. For example, web server 310 may host a financial service provider website that a user device may access by providing an attempted login that are authenticated by the trip planning system 220. According to some embodiments, web server 310 may include software tools, similar to those described with respect to user device 302 above, that may allow web server 310 to obtain network identification data from user device 302. The web server may also be hosted by an online provider of website hosting, networking, cloud, or backup services, such as Microsoft Azure™ or Amazon Web Services™.

The local network 312 may include any type of computer networking arrangement used to exchange data in a localized area, such as WiFi, Bluetooth™, Ethernet, and other suitable network connections that enable components of the customer organization system 308 to interact with one another and to connect to the network 306 for interacting with components in the system 300 environment. In some embodiments, the local network 312 may include an interface for communicating with or linking to the network 306. In other embodiments, certain components of the customer organization system 308 may communicate via the network 306, without a separate local network 306.

The customer organization system 308 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 302 may be able to access customer organization system 308 using the cloud computing environment. User device 302 may be able to access customer organization system 308 using specialized software. The cloud computing environment may eliminate the need to install specialized software on user device 302.

In accordance with certain example implementations of the disclosed technology, the customer organization system 308 may include one or more computer systems configured to compile data from a plurality of sources the trip planning system 220, web server 310, and/or the database 316. The trip planning system 220 may correlate compiled data, analyze the compiled data, arrange the compiled data, generate derived data based on the compiled data, and store the compiled and derived data in a database such as the database 316. According to some embodiments, the database 316 may be a database associated with an organization and/or a related entity that stores a variety of information relating to customers, transactions, ATM, and business operations. The database 316 may also serve as a back-up storage device and may contain data and information that is also stored on, for example, database 260, as discussed with reference to FIG. 2.

Embodiments consistent with the present disclosure may include datasets. Datasets may comprise actual data reflecting real-world conditions, events, and/or measurements. However, in some embodiments, disclosed systems and methods may fully or partially involve synthetic data (e.g., anonymized actual data or fake data). Datasets may involve numeric data, text data, and/or image data. For example, datasets may include transaction data, financial data, demographic data, public data, government data, environmental data, traffic data, network data, transcripts of video data, genomic data, proteomic data, and/or other data. Datasets of the embodiments may be in a variety of data formats including, but not limited to, PARQUET, AVRO, SQLITE, POSTGRESQL, MYSQL, ORACLE, HADOOP, CSV, JSON, PDF, JPG, BMP, and/or other data formats.

Datasets of disclosed embodiments may have a respective data schema (e.g., structure), including a data type, key-value pair, label, metadata, field, relationship, view, index, package, procedure, function, trigger, sequence, synonym, link, directory, queue, or the like. Datasets of the embodiments may contain foreign keys, for example, data elements that appear in multiple datasets and may be used to cross-reference data and determine relationships between datasets. Foreign keys may be unique (e.g., a personal identifier) or shared (e.g., a postal code). Datasets of the embodiments may be “clustered,” for example, a group of datasets may share common features, such as overlapping data, shared statistical properties, or the like. Clustered datasets may share hierarchical relationships (e.g., data lineage).

### EXAMPLE USE CASE

The following example use case describes an example of a typical user flow pattern. This section is intended solely for explanatory purposes and not in limitation.

In one example, Katherine works as a relationship manager at a bank. She decides to plan a trip to Rhode Island to visit current clients and meet new clients in the restaurant industry. Katherine logs into a web application for trip planning system 220 on her computer. The web application asks Katherine for criteria for her trip using a graphical user interface. Katherine indicates that she wants to meet with clients who are in the restaurant industry over two days in Providence, Rhode Island. She also specifies that she wants a combination of new and current clients and wants the trip to be in between strenuous and relaxing.

The trip planning system 220 receives this criteria and searches for information based on the criteria. This is specifically potential clients and current clients in the restaurant industry in and around Providence, Rhode Island. The trip planning system 220 locates 10 potential new restaurants in the specified area and ranks them on a list according to potential revenue based on location and categorizes all of them as “drop-by.” The trip planning system 220 also locates 7 current restaurant clients. Of the 7 current clients, the trip planning system 220 eliminates 3 because they were just visited by another relationship manager. The trip planning system 220 also adds one nightclub client that recently had a bad experience with a disputed charge. The 4 restaurants are categorized as “schedule appointment” and single nightclub client is categorized as “drop-by.” All are added to the ranked list of potential leads.

The trip planning system 220 then generates a graphical user interface and sends it to Katherine's computer. The graphical user interface includes a map and a list of the 10 new potential leads, and 5 current potential leads. Katherine chooses to visit 6 of the new potential leads and 4 of the current potential leads, including the nightclub. Katherine indicates that she should visit the corporate office of the nightclub at around 5 pm. This information is then received by trip planning system 220.

The trip planning system 220 then generates a plan based on the data provided. The trip planning system 220 assigns a route for Katherine to take between the 10 locations. The trip planning system 220 choses to visit the restaurants that are open for lunch and dinner in the morning and the restaurants that are only open for dinner in the afternoon. The trip planning system 220 suggests Katherine will have one overnight stay and suggests a local hotel in between her stops. The trip planning system 220 sends out trip data to have optimized road directions for Katherine to use while driving. The trip planning system 220 generates and transmits a graphical user interface showing this information to Katherine's computer.

Katherine makes a few changes to the plan based on the map view. Katherine calls new potential leads listed to schedule appointments. She inputs the appointment she scheduled into trip planning system 220, which then modifies the plan and presents Katherine with a new graphical user interface showing the new plan. Katherine also allows trip planning system 220 to send automated emails to the current potential leads to schedule appointments. One of the current clients answers affirmatively to accept the appointments. One suggests an alternative time and the last one does not answer. The trip planning system 220 reroutes Katherine's plan accordingly to accommodate the alternative time and changes the remaining client that did not answer to a “drop-by” option at a known non-busy time.

Katherine saves the plan using the graphical user interface. Later that month, when Katherine starts her travels, she uses her smartphone to open the plan and check-off when she has completed certain tasks.

In some examples, disclosed systems or methods may involve one or more of the following clauses:
Clause 1: A trip planning system comprising: one or more processors; memory in communication with the one or more processors and storing instructions that are configured to cause the system to: receive criteria; retrieve, based on the criteria, candidate data; generate, using a first machine learning model, potential leads according to the criteria and the candidate data; receive timing data and preference data; and generate, using a second machine learning model, a plan based on the potential leads, the timing data, and the preference data; and store the plan, wherein the plan can be accessed by a user device.
Clause 2: The trip planning system of clause 1, wherein: the criteria comprises a total number of potential leads, a number of current customers, a number of potential new customers, a preferred category of prospect, a geographical area, an amount of time, user data, or combinations thereof, and the candidate data comprises opening data, closing data, frequency data, feedback from a plurality of users, or combinations thereof.
Clause 3: The trip planning system of clause 1, wherein the potential leads comprise a recommendation for an appointment or a drop-by.
Clause 4: The trip planning system of clause 1, wherein: the potential leads are potential new customers, and the memory stores further instructions that are configured to cause the system to sort the potential leads using the first machine learning model by potential earnings.
Clause 5: The trip planning system of clause 4, wherein the first machine learning model predicts the potential earnings of a new prospect based the candidate data and supplemental data on past, similar prospects in an area.
Clause 6: The trip planning system of clause 1, wherein the second machine learning model uses the candidate data to determine when a certain potential lead of the potential leads is not busy to complete the plan according to the timing data and the preference data.
Clause 7: The trip planning system of clause 1, wherein: the preference data comprises one or more selections of the potential leads, and the memory stores further instructions that are configured to cause the system to update the first machine learning model based on the preference data.
Clause 8: The trip planning system of clause 1, wherein the preference data further comprises a variable scheduling preference varying on a continuum from relaxed to strenuous.
Clause 9: The trip planning system of clause 1, wherein the memory stores further instructions that are configured to cause the system to: transmit, to a third party, plan data created from the plan; receive, from third party, optimized travel information based on the plan data; and adjusting the plan based on the optimized travel information.
Clause 10: The trip planning system of clause 1, wherein the memory stores further instructions that are configured to cause the system to: generate a first graphical user interface comprising an interactive map with the potential leads and travel information from the plan; transmit, to the user device, the first graphical user interface for display; receive, from the user device, a user input, changing the travel information on the interactive map; change the plan to match the travel information changed by the user input; update the first graphical user interface to match the plan that was changed to create an updated first graphical user interface; and transmit, to the user device, the updated first graphical user interface for display.
Clause 11: A trip planning system comprising: one or more processors; memory in communication with the one or more processors and storing instructions that are configured to cause the system to: generate a first graphical user interface to prompt criteria from a user; transmit, to a user device, the first graphical user interface for display; receive criteria from the user device; retrieve, based on the criteria, candidate data; generate, using a first machine learning model, potential leads according to the criteria and the candidate data; generate a second graphical user interface comprising the potential leads, prompting timing data, and prompting preference data from the user; transmit, to the user device, the second graphical user interface for display; receive, from the user device, the timing data and the preference data; generate, using a second machine learning model, a plan based on the potential leads, the timing data, and the preference data; generate a third graphical user interface comprising an interactive map with the potential leads and travel information from the plan; and transmit, to the user device, the third graphical user interface for display.
Clause 12: The trip planning system of clause 11, wherein the third graphical user interface further comprises prompting the user to, for each of the potential leads, allow automated scheduling and memory stores further instructions that are configured to cause the system to: receive, from the user device, a selection of potential leads to use automated scheduling; and send, to third party user devices associated with the selection of potential leads, by email or text message, an invitation.
Clause 13: The trip planning system of clause 12, wherein the memory stores further instructions that are configured to cause the system to: receive, from the third party user devices associated with the selection of potential leads, appointment information; and revise, using the second machine learning model, the plan based on the appointment information.
Clause 14: The trip planning system of clause 11, wherein the third graphical user interface further comprises prompting the user to enter appointment information and the memory stores further instructions that are configured to cause the system to: receive, from the user device, the appointment information; and revise, using the second machine learning model, the plan based on the appointment information.
Clause 15: The trip planning system of clause 11, wherein the memory stores further instructions that are configured to cause the system to: generate a fourth graphical user interface comprising an interactive list with the potential leads and the travel information from the plan; and transmit, to the user device, the fourth graphical user interface for display.
Clause 16: The trip planning system of clause 11, wherein the potential leads are current customers.
Clause 17: A trip planning system comprising: one or more processors; memory in communication with the one or more processors and storing instructions that are configured to cause the system to: passively receive criteria from a user device; retrieve, based on the criteria, candidate data; automatically generate, using a first machine learning model, potential leads according to the criteria and the candidate data; automatically transmit, to the user device, recommendations for potential leads; receive timing data and preference data; and generate, using a second machine learning model, a plurality of plans based on the potential leads, the timing data, and the preference data; and store the plurality of plans, wherein the plurality of plans can be accessed by the user device.
Clause 18: The trip planning system of clause 17, wherein the memory stores further instructions that are configured to cause the system to: generate a first graphical user interface comprising a list of the plurality of plans and prompting a response from the user device; and transmit to the first graphical user interface to the user device for display.
Clause 19: The trip planning system of clause 18, wherein the memory stores further instructions that are configured to cause the system to: receive, from the user device, a selection of a plan from the plurality of plans.
Clause 20: The trip planning system of clause 19, wherein the memory stores further instructions that are configured to cause the system to: generate a second graphical user interface comprising an interactive map with the potential leads and travel information from the selection; and transmit to the second graphical user interface to the user device for display.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A trip planning system comprising:
one or more processors;
memory in communication with the one or more processors and storing instructions that are configured to cause the system to:
receive criteria;
retrieve, based on the criteria, candidate data;
generate, using a first machine learning model, potential leads according to the criteria and the candidate data;
receive timing data and preference data;
generate, using a second machine learning model, a plan based on the potential leads, the timing data, and the preference data; and
store the plan, wherein the plan can be accessed by a user device.

2. (canceled)

3. (canceled)

4. The trip planning system of claim 1, wherein:
the criteria comprises a total number of potential leads, a number of current customers, a number of potential new customers, a preferred category of prospect, a geographical area, an amount of time, user data, or combinations thereof, and
the candidate data comprises opening data, closing data, frequency data, feedback from a plurality of users, or combinations thereof.

5. The trip planning system of claim 1, wherein the potential leads comprise a recommendation for an appointment or a drop-by.

6. The trip planning system of claim 1, wherein:
the potential leads are potential new customers, and
the memory stores further instructions that are configured to cause the system to sort the potential leads using the first machine learning model by potential earnings.

7. The trip planning system of claim 6, wherein the first machine learning model predicts the potential earnings of a new prospect based the candidate data and supplemental data on past, similar prospects in an area.

8. The trip planning system of claim 1, wherein the second machine learning model uses the candidate data to determine when a certain potential lead of the potential leads is not busy to complete the plan according to the timing data and the preference data.

9. The trip planning system of claim 1, wherein:
the preference data comprises one or more selections of the potential leads, and
the memory stores further instructions that are configured to cause the system to update the first machine learning model based on the preference data.

10. The trip planning system of claim 1, wherein the preference data further comprises a variable scheduling preference varying on a continuum from relaxed to strenuous.

11. The trip planning system of claim 1, wherein the memory stores further instructions that are configured to cause the system to:
transmit, to a third party, plan data created from the plan;
receive, from third party, optimized travel information based on the plan data; and
adjusting the plan based on the optimized travel information.

12. The trip planning system of claim 1, wherein the memory stores further instructions that are configured to cause the system to:
generate a first graphical user interface comprising an interactive map with the potential leads and travel information from the plan;
transmit, to the user device, the first graphical user interface for display;
receive, from the user device, a user input, changing the travel information on the interactive map;
change the plan to match the travel information changed by the user input;
update the first graphical user interface to match the plan that was changed to create an updated first graphical user interface; and
transmit, to the user device, the updated first graphical user interface for display.

13. A trip planning system comprising:
one or more processors;
memory in communication with the one or more processors and storing instructions that are configured to cause the system to:
generate a first graphical user interface to prompt criteria from a user;
transmit, to a user device, the first graphical user interface for display;
receive criteria from the user device;
retrieve, based on the criteria, candidate data;
generate, using a first machine learning model, potential leads according to the criteria and the candidate data;
generate a second graphical user interface comprising the potential leads, prompting timing data, and prompting preference data from the user;
transmit, to the user device, the second graphical user interface for display;
receive, from the user device, the timing data and the preference data;
generate, using a second machine learning model, a plan based on the potential leads, the timing data, and the preference data;
generate a third graphical user interface comprising an interactive map with the potential leads and travel information from the plan; and
transmit, to the user device, the third graphical user interface for display.

14. The trip planning system of claim 13, wherein the third graphical user interface further comprises prompting the user to, for each of the potential leads, allow automated scheduling and memory stores further instructions that are configured to cause the system to:
receive, from the user device, a selection of potential leads to use automated scheduling; and
send, to third party user devices associated with the selection of potential leads, by email or text message, an invitation.

15. The trip planning system of claim 14, wherein the memory stores further instructions that are configured to cause the system to:
receive, from the third party user devices associated with the selection of potential leads, appointment information; and
revise, using the second machine learning model, the plan based on the appointment information.

16. The trip planning system of claim 13, wherein the third graphical user interface further comprises prompting the user to enter appointment information and the memory stores further instructions that are configured to cause the system to:
receive, from the user device, the appointment information; and
revise, using the second machine learning model, the plan based on the appointment information.

17. The trip planning system of claim 13, wherein the memory stores further instructions that are configured to cause the system to:
generate a fourth graphical user interface comprising an interactive list with the potential leads and the travel information from the plan; and
transmit, to the user device, the fourth graphical user interface for display.

18. The trip planning system of claim 13, wherein the potential leads are current customers.

19. A trip planning system comprising:
one or more processors;
memory in communication with the one or more processors and storing instructions that are configured to cause the system to:
passively receive criteria from a user device;
retrieve, based on the criteria, candidate data;
automatically generate, using a first machine learning model, potential leads according to the criteria and the candidate data;
automatically transmit, to the user device, recommendations for potential leads;
receive timing data and preference data; and
generate, using a second machine learning model, a plurality of plans based on the potential leads, the timing data, and the preference data; and
store the plurality of plans, wherein the plurality of plans can be accessed by the user device.

20. The trip planning system of claim 19, wherein the memory stores further instructions that are configured to cause the system to:
generate a first graphical user interface comprising a list of the plurality of plans and prompting a response from the user device; and
transmit to the first graphical user interface to the user device for display.

21. The trip planning system of claim 20, wherein the memory stores further instructions that are configured to cause the system to:
receive, from the user device, a selection of a plan from the plurality of plans.

22. The trip planning system of claim 21, wherein the memory stores further instructions that are configured to cause the system to:
generate a second graphical user interface comprising an interactive map with the potential leads and travel information from the selection; and
transmit to the second graphical user interface to the user device for display.
